(19) United States
(12) Patent Application Publication
(10) Pub. No.: US 2018/0359684 A1
(43) Pub. Date: Dec. 13, 2018

(54) METHOD AND APPARATUS FOR ACQUIRING NETWORK SERVICE VIA FREQUENCY BAND INFORMATION

(71) Applicant: ZTE CORPORATION, Shenzhen City (CN)

(72) Inventors: Li ZHUANG, Shenzhen City (CN); Haitao XIANG, Shenzhen City (CN)

(73) Assignee: ZTE CORPORATION, Shenzhen City (CN)

(21) Appl. No.: 15/556,095

(22) PCT Filed: Sep. 15, 2015
(86) PCT No.: PCT/CN2015/089653

§ 371 Date: Sep. 6, 2017

(30) Foreign Application Priority Data
Mar. 6, 2015 (CN) 201510100889.5

(51) Int. Cl. H04W 48/14; H04W 72/04; H04W 76/10; H04W 60/04; H04W 28/02

(52) U.S. Cl. CPC H04W 48/14; H04W 72/042; H04W 72/0453; H04W 60/04; H04W 28/0215; H04W 76/10

(57) ABSTRACT

A method for acquiring a network service via frequency band information, applied to a terminal device, includes: establishing, by the terminal device, a channel connection; and generating final frequency band information of each system of the terminal device according to a model of the terminal device, a mobile country code (MCC) and a mobile network code (MNC) when determining that the final frequency band information of the terminal device is not generated.

### CROSS-REFERENCE TO RELATED APPLICATION

This application is the U.S. national phase of PCT Application No. PCT/CN2015/089653 filed Sep. 15, 2015, which claims priority to Chinese Application No. 201510100889.5 filed Mar. 6, 2015, the disclosures of which are incorporated in their entirety by reference herein.

### TECHNICAL FIELD

The present disclosure relates to, but is not limited to, the field of mobile communication technology.

### BACKGROUND

With development of wireless communication technology today, network systems in every country in the world are more and more, and the supported frequency bands are increasing continually as well. With the continuous integration of global services, terminal devices need to support more and more frequency bands to meet the requirements for registering to networks in different countries. At present, the global services are increasing and terminal users are also increasing constantly, so that due to too many users on some network frequency bands, network performance is degraded, causing network congestion.

### SUMMARY

The following is a summary of the subject matter described herein in detail. This summary is not intended to limit the protection scope of the claims.

This disclosure provides a method and apparatus for acquiring a network service via frequency band information to improve efficiency of acquisition of the network service.

A method for acquiring a network service via frequency band information, applied to a terminal device, includes:

establishing, by the terminal device, a channel connection;

generating final frequency band information of each system of the terminal device according to a model of the terminal device, a mobile country code (MCC) and a mobile network code (MNC) when determining that final frequency band information of the terminal device is not generated; and

acquiring, by the terminal device, the network service according to the final frequency band information.

In an exemplary embodiment, the final frequency band information includes final enable frequency band information and final disable frequency band information; and

generating final frequency band information of each system of the terminal device according to a model of the terminal device, a mobile country code (MCC) and a mobile network code (MNC) when determining that final frequency band information of the terminal device is not generated includes:

acquiring the MCC and the MNC of a network to which the terminal device registers;

finding, in a configuration information table, enable frequency band information and disable frequency band information of the each system of the terminal device according to the model of the terminal device, the MCC and the MNC; and

generating the final enable frequency band information and the final disable frequency band information of the each system of the terminal device according to frequency band information of the each system supported by the terminal device and the found enable frequency band information and the found final disable frequency band information of the each system of the terminal device.

In an exemplary embodiment, generating the final enable frequency band information and the final disable frequency band information of the each system of the terminal device according to frequency band information of the each system supported by the terminal device and the found enable frequency band information and the found disable frequency band information of the each system of the terminal device includes:

performing “AND” operation on the frequency band information of the each system supported by the terminal device and the found enable frequency band information of the each system of the terminal device in terms of the each system respectively, and then performing “OR” operation on a result obtained after the “AND” operation for the each system, and using a result of the “OR” operation as the final enable frequency band information of the terminal device; and

performing “AND” operation on the frequency band information of the each system supported by the terminal device and the found disable frequency band information of the each system of the terminal device in terms of the each system respectively, and then performing

“AND” operation again on a result obtained after the “AND” operation for the each system, and using a result of the “AND” operation performed again as the final disable frequency band information of the terminal device.

In an exemplary embodiment, acquiring, by the terminal device, the network service according to the final frequency band information includes:

re-initiating a network service acquisition request carrying the final enable frequency band information and the final disable frequency band information of the terminal device.

In an exemplary embodiment, a system of the terminal device includes one or more of the following systems: Global System for Mobile Communications (GSM), Wideband Code Division Multiple Access (WCDMA) and Long Term Evolution (LTE).

An apparatus for acquiring a network service via frequency band information, provided in a terminal device, includes:

a connection module configured to establish a channel connection;

a generation module configured to generate final frequency band information of each system of the terminal device according to a model of the terminal device, a mobile country code (MCC) and a mobile network code (MNC) when determining that final frequency band information of the terminal device is not generated; and

a service acquisition module configured to acquire the network service according to the final frequency band information.

In an exemplary embodiment, the final frequency band information includes final enable frequency band information and final disable frequency band information; and

the generation module includes an acquiring submodule, a finding submodule and a generating submodule, herein

the acquiring submodule is configured to acquiring the MCC and the MNC of a network with which the terminal device registers;

the finding submodule is configured to find, in a configuration information table, enable frequency band information and disable frequency band information of the each system of the terminal device according to the model of the terminal device, the MCC and the MNC; and

the generating submodule is configured to generate the final enable frequency band information and the final disable frequency band information of the each system of the terminal device according to frequency band information of the each system supported by the terminal device and the found enable frequency band information and the found disable frequency band information of the each system of the terminal device.

In an exemplary embodiment, the generating submodule is configured to perform “AND” operation on the frequency band information of the each system supported by the terminal device and the found enable frequency band information of the each system of the terminal device in terms of the each system respectively, and then perform “OR” operation on a result obtained after the “AND” operation for the each system, and use a result of the “OR” operation as the final enable frequency band information of the terminal device; and perform “AND” operation on the frequency band information of the each system supported by the terminal device and the found disable frequency band information of the each system of the terminal device in terms of each system respectively, and then perform “AND” operation again on a result obtained after the “AND” operation for the each system, and use a result of the “AND” operation performed again as the final disable frequency band information of the terminal device.

In an exemplary embodiment, the service acquisition module is configured to re-initiate a network service acquisition request carrying the final enable frequency band information and the final disable frequency band information of the terminal device.

In an exemplary embodiment, a system of the terminal device includes one or more of the following systems: Global System for Mobile Communications (GSM), Wideband Code Division Multiple Access (WCDMA) and Long Term Evolution (LTE).

A computer readable storage medium has computer executable instructions stored therein used to implement any one method described above.

In the scheme described above, the frequency band to which the terminal registers is controlled by acquiring the mobile country code (MCC) and the mobile network code (MNC) of the registered public land mobile network (RPLMN) to which the terminal registers and according to the model of the terminal, thereby improving efficiently the time for the terminal to acquire the network service and improving the efficiency of the acquisition of the network service and the utilization of the network.

After the accompanying drawings and detailed description are read and understood, other aspects can be understood.

### BRIEF DESCRIPTION OF DRAWINGS

FIG. 1 is a flow chart of a method for acquiring a network service via frequency band information in accordance with a first embodiment of the present disclosure.

FIG. 2 is a block diagram of an apparatus for acquiring a network service via frequency band information in accordance with the first embodiment of the present disclosure.

FIG. 3 is a flow chart of a method for acquiring a network service via frequency band information in accordance with a second embodiment of the present disclosure.

FIG. 4 is a schematic diagram of a data storage structure in a configuration information table in accordance with the second embodiment of the present disclosure.

### DETAILED DESCRIPTION

Embodiments of the present disclosure will be described in detail below in conjunction with the accompanying drawings. It is should be noted that the embodiments in the present application and features in the embodiments can be combined with each other arbitrarily without conflict.

### The First Embodiment

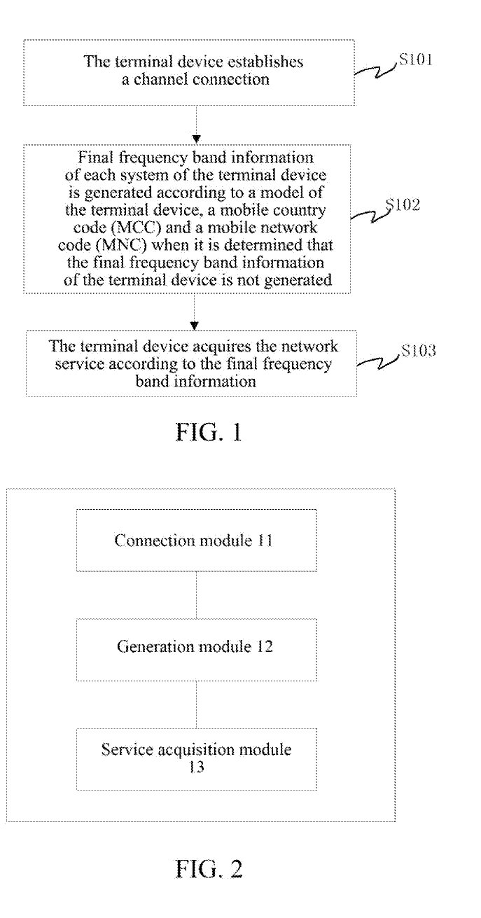

As shown in FIG. 1, an embodiment of the present disclosure provides a method for acquiring a network service via frequency band information, applied to a terminal device. The method includes the following steps S101-S103.

In step S101, the terminal device establishes a channel connection.

In step S102, final frequency band information of each system of the terminal device is generated according to a model of the terminal device, a mobile country code (MCC) and a mobile network code (MNC) when it is determined that the final frequency band information of the terminal device is not generated.

Herein, the final frequency band information includes final enable frequency band information and final disable frequency band information. The system of the terminal device includes one or more of the following systems: Global System for Mobile Communications (GSM), Wideband Code Division Multiple Access (WCDMA) and Long Term Evolution (LTE).

The step S102 may include:

the MCC and the MNC of a network to which the terminal device registers are acquired;

enable frequency band information and disable frequency band information of each system of the terminal device are found in a configuration information table according to the model of the terminal device, the MCC and the MNC; and

the final enable frequency band information and final disable frequency band information of each system of the terminal device are generated according to frequency band information of each system supported by the terminal device and the found enable frequency band information and the found disable frequency band information of each terminal of the terminal device.

The step S102 may further includes:

“AND” operation is performed on the frequency band information of each system supported by the terminal device and the found enable frequency band information of each system of the terminal device in terms of each system respectively, and then “OR” operation is performed on a result obtained after the “AND” operation for each system, and a result of the “OR” operation is used as the final enable frequency band information of the terminal device; and

“AND” operation is performed on the frequency band information of each system supported by the terminal device and the found disable frequency band information of each system of the terminal device in terms of each system respectively, and then “AND” operation is performed again on a result obtained after the “AND” operation for each system, and a result of the “AND” operation performed again is used as the final disable frequency band information of the terminal device.

In step S103, the terminal device acquires the network service according to the final frequency band information.

The step S103 may include: a network service acquisition request is re-initiated; herein the network service acquisition request carries the final enable frequency band information and the final disable frequency band information of the terminal device.

As shown in FIG. 2, an embodiment of the present disclosure further provides an apparatus for acquiring a network service via frequency band information, provided in a terminal device. The apparatus includes a connection module 11, a generation module 12 and a service acquisition module 13.

The connection module 11 is configured to establish a channel connection.

The generation module 12 is configured to generate final frequency band information of each system of the terminal device according to a model of the terminal device, a mobile country code (MCC) and a mobile network code (MNC) when determining that the final frequency band information of the terminal device is not generated.

The acquiring service module 13 is configured to acquire the network service according to the final frequency band information.

The final frequency band information includes final enable frequency band information and final disable frequency band information. The system of the terminal device includes one or more of the following systems: Global System for Mobile Communications (GSM), Wideband Code Division Multiple Access (WCDMA) and Long Term Evolution (LTE).

In an exemplary embodiment, the generation module 12 includes an acquiring submodule, a finding submodule and a generating submodule.

The acquiring submodule is configured to acquire the MCC and MNC of a network to which the terminal device registers.

The finding submodule is configured to find, in a configuration information table, enable frequency band information and disable frequency band information of each system of the terminal device according to the model of the terminal device, the MCC and the MNC.

The generating submodule is configured to generate the final enable frequency band information and the final disable frequency band information of each system of the terminal device according to the frequency band information of each system supported by the terminal device and the found enable frequency band information and the found disable frequency band information of each system of the terminal device.

In an exemplary embodiment, the generating submodule is configured to perform “AND” operation on the frequency band information of each system supported by the terminal device and the found enable frequency band information of each system of the terminal device in terms of each system respectively, then perform “OR” operation on a result obtained after the “AND” operation for each system, and use a result of the “OR” operation as the final enable frequency band information of the terminal device; and perform “AND” operation on the frequency band information of each system supported by the terminal device and the found disable frequency band information of each system of the terminal device in terms of each system respectively, then perform “AND” operation again on a result obtained after the “AND” operation for each system, and use a result of the “AND” operation performed again as the final disable frequency band information of the terminal device.

The acquiring service module 13 is configured to re-initiate a network service acquisition request, herein the network service acquisition request carries the final enable frequency band information and the final disable frequency band information of the terminal device.

In the scheme described above, the network service is acquired via the frequency band information, thereby decreasing the time to acquire the network service and improving the utilization of the network.

### The Second Embodiment

Taking a mobile terminal device as an example, the technical scheme of the embodiments of the present disclosure will be further described below.

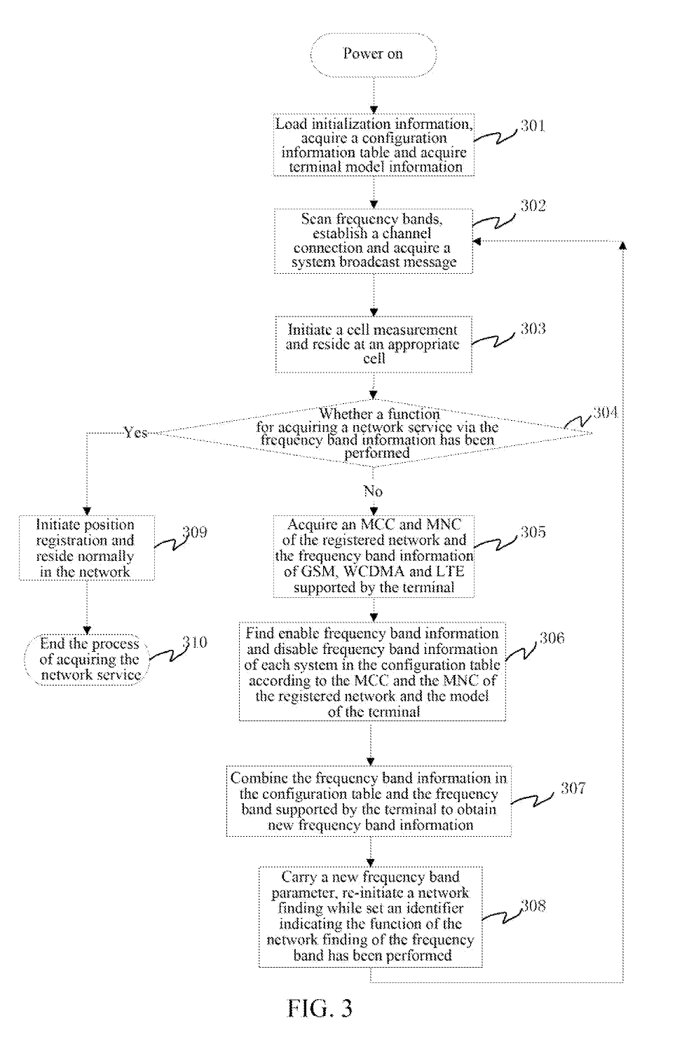

As shown in FIG. 3, an embodiment of the present disclosure provides a method for acquiring a network service via frequency band information, applied to a terminal device. The method includes the following steps 301-310.

In step 301, the mobile terminal device is powered on to start, loads initialization information, acquires a configuration information table, acquires a model of the mobile terminal device, and acquires a network service acquisition identifier which is False by default at the initialization.

In step 302, the mobile terminal device scans frequency bands, establishes a channel connection and acquires a system broadcast message.

In step 303, the mobile terminal initiates a cell measurement and resides at an appropriate cell.

In step 304, it is determined whether the function for acquiring a network service via the frequency band information has been performed, and if yes, step 309 will be continued to be executed, and if no, step 305 will be continued to be executed.

In step 305, an MCC and MNC of a network to the mobile terminal device registers are acquired while the frequency band information of each system supported by the terminal is acquired from a signaling message.

In step 306, corresponding enable frequency band and disable frequency band information of each system are found in the configuration information table according to the MCC and MNC of the registered network and the model of the terminal.

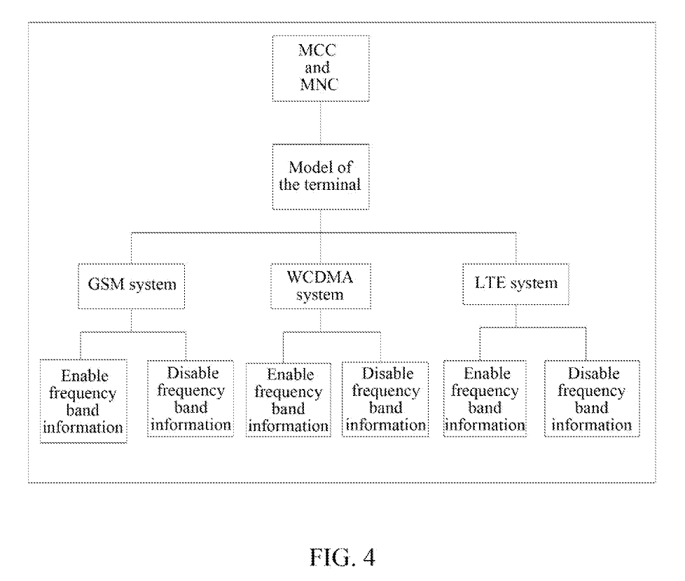

FIG. 4 is a schematic diagram of a data storage structure in a configuration information table. In this configuration information table, the enable and disable frequency band information for three systems, i.e., GSM, WCDMA and LTE, of the terminal device can be determined uniquely according to the MCC, MNC and the model of the terminal device. For example, the MCC/MNC 46000 and the model A of the terminal device correspond to enable and disable frequency band information of three systems, i.e., GSM, WCDMA and LTE, of the terminal device, and the MCC/MNC 46000 and the model B of the terminal device correspond to another group of enable and disable frequency band information.

In step 307, “AND” operation is performed on the frequency band information of each system supported by the mobile terminal device and the acquired enable frequency band information of each system in the configuration information table, and then “OR” operation is performed on the frequency band information supported by the mobile terminal device and a result obtained after the “AND” operation to obtain the frequency band information of the mobile terminal device required to be enabled on the system, and “AND” operation is performed on the frequency band information of the system supported by the mobile terminal device and the disable frequency band information of the system in the configuration information table to obtain finally disable frequency band information of the system.

In step 308, new frequency band information is carried, and a network service acquisition request is re-initiated while a network service acquisition identifier is set to be True, and step 302 will be executed.

In step 309, position registration is initiated, and the network is normally resided and the network service is acquired.

In step 310, the process of acquiring the network service ends and the mobile terminal device resides in the network normally.

People having ordinary skill in the art may understand that all or part of steps in the embodiments described above can be carried out by using computer programs, which may be stored in a computer readable storage medium. The computer programs, when executed on the corresponding hardware platform (such as a system, a device, an apparatus and a component and the like), include one or a combination of steps in the method embodiments.

In an exemplary embodiment, all or part of steps in the embodiments described above can be carried out by using integrated circuits. These steps can be implemented by making them one by one into individual integrated circuit modules or by making a plurality of modules thereof into a single integrated circuit module.

Various apparatuses/functional modules/functional units in the embodiments described above, which can be implemented by using general computing apparatuses, can be centralized on a single computing apparatus or distributed in a network formed by multiple computing apparatus.

Various apparatuses/functional modules/functional units in the embodiments described above, when implemented in a form of software functional module and sold or used as stand-stone products, can be stored in a computer readable storage medium. The computer readable storage medium mentioned above may be a read-only memory, a magnetic disk or an optical disk, etc.

### INDUSTRIAL APPLICABILITY

In the embodiments of the present disclosure, the frequency band in which the terminal registers is controlled by acquiring the MCC and the MNC registered by the terminal and according to the model of the terminal, thereby improving efficiently the time for the terminal to acquire the network service, and improving the efficiency of the acquisition of the network service and the utilization of the network.

1. A method for acquiring a network service via frequency band information, applied to a terminal device, comprising:
establishing, by the terminal device, a channel connection;
generating final frequency band information of each system of the terminal device according to a model of the terminal device, a mobile country code, MCC, and a mobile network code, MNC, when determining that final frequency band information of the terminal device is not generated; and
acquiring, by the terminal device, the network service according to the final frequency band information.

2. The method according to claim 1, wherein
the final frequency band information comprises final enable frequency band information and final disable frequency band information; and
the generating final frequency band information of each system of the terminal device according to a model of the terminal device, a mobile country code, MCC, and a mobile network code, MNC, when determining that final frequency band information of the terminal device is not generated comprises:
acquiring the MCC and the MNC of a network to which the terminal device registers;
finding, in a configuration information table, enable frequency band information and disable frequency band information of the each system of the terminal device according to the model of the terminal device, the MCC and the MNC; and
generating the final enable frequency band information and the final disable frequency band information of the each system of the terminal device according to frequency band information of the each system supported by the terminal device and the found enable frequency band information and the found disable frequency band information of the each system of the terminal device.

3. The method according to claim 2, wherein
the generating the final enable frequency band information and the final disable frequency band information of the each system of the terminal device according to frequency band information of the each system supported by the terminal device and the found enable frequency band information and the found disable frequency band information of the each system of the terminal device comprises:
performing “AND” operation on the frequency band information of the each system supported by the terminal device and the found enable frequency band information of the each system of the terminal device in terms of the each system respectively, and then performing “OR” operation on a result obtained after the “AND” operation for the each system, and using a result of the “OR” operation as the final enable frequency band information of the terminal device; and
performing “AND” operation on the frequency band information of the each system supported by the terminal device and the found disable frequency band information of the each system of the terminal device in terms of the each system respectively, and then performing “AND” operation again on a result obtained after the “AND” operation for the each system, and using a result of the “AND” operation performed again as the final disable frequency band information of the terminal device.

4. The method according to claim 2, wherein
the acquiring, by the terminal device, the network service according to the final frequency band information comprises:
re-initiating a network service acquisition request, wherein the network service acquisition request carries the final enable frequency band information and the final disable frequency band information of the terminal device.

5. The method according to claim 1, wherein
a system of the terminal device comprises one or more of the following systems: Global System for Mobile Communications, GSM, Wideband Code Division Multiple Access, WCDMA, and Long Term Evolution, LTE.

6. An apparatus for acquiring a network service via frequency band information, provided in a terminal device, comprising:
a connection module configured to establish a channel connection;
a generation module configured to generate final frequency band information of each system of the terminal device according to a model of the terminal device, a mobile country code, MCC, and a mobile network code, MNC, when determining that final frequency band information of the terminal device is not generated; and
a service acquisition module configured to acquire the network service according to the final frequency band information.

7. The apparatus according to claim 6, wherein
the final frequency band information comprises final enable frequency band information and final disable frequency band information; and
the generation module comprises an acquiring submodule, a finding submodule and a generating submodule, wherein
the acquiring submodule is configured to acquiring the MCC and the MNC of a network to which the terminal device registers;
the finding submodule is configured to find, in a configuration information table, enable frequency band information and disable frequency band information of the each system of the terminal device according to the model of the terminal device, the MCC and the MNC; and
the generating submodule is configured to generate the final enable frequency band information and the final disable frequency band information of the each system of the terminal device according to frequency band information of the each system supported by the terminal device and the found enable frequency band information and the found disable frequency band information of the each system of the terminal device.

8. The apparatus according to claim 7, wherein
the generating submodule is configured to perform “AND” operation on the frequency band information of the each system supported by the terminal device and the found enable frequency band information of the each system of the terminal device in terms of the each system respectively, and then perform “OR” operation on a result obtained after the “AND” operation for the each system, and use a result of the “OR” operation as the final enable frequency band information of the terminal device; and perform “AND” operation on the frequency band information of the each system supported by the terminal device and the found disable frequency band information of the each system of the terminal device in terms of the each system respectively, and then perform “AND” operation again on a result obtained after the “AND” operation for the each system, and use a result of the “AND” operation performed again as the final disable frequency band information of the terminal device.

9. The apparatus according to claim 8, wherein
the service acquisition module is configured to re-initiate a network service acquisition request, wherein the network service acquisition request carries the final enable frequency band information and the final disable frequency band information of the terminal device.

10. The apparatus according to claim 6, wherein,
a system of the terminal device comprises one or more of the following systems: Global System for Mobile Communications, GSM, Wideband Code Division Multiple Access, WCDMA, and Long Term Evolution, LTE.

11. A computer readable storage medium where computer executable instructions are stored, wherein the computer executable instructions are used to implement the method according to claim 1.

12. The method according to claim 2, wherein
a system of the terminal device comprises one or more of the following systems: Global System for Mobile Communications, GSM, Wideband Code Division Multiple Access, WCDMA, and Long Term Evolution, LTE.

13. The method according to claim 3, wherein
a system of the terminal device comprises one or more of the following systems: Global System for Mobile Communications, GSM, Wideband Code Division Multiple Access, WCDMA, and Long Term Evolution, LTE.

14. The method according to claim 4, wherein
a system of the terminal device comprises one or more of the following systems: Global System for Mobile Communications, GSM, Wideband Code Division Multiple Access, WCDMA, and Long Term Evolution, LTE.

15. The apparatus according to claim 7, wherein,
a system of the terminal device comprises one or more of the following systems: Global System for Mobile Communications, GSM, Wideband Code Division Multiple Access, WCDMA, and Long Term Evolution, LTE.

16. The apparatus according to claim 8, wherein,
a system of the terminal device comprises one or more of the following systems: Global System for Mobile Communications, GSM, Wideband Code Division Multiple Access, WCDMA, and Long Term Evolution, LTE.

17. The apparatus according to claim 9, wherein,
a system of the terminal device comprises one or more of the following systems: Global System for Mobile Communications, GSM, Wideband Code Division Multiple Access, WCDMA, and Long Term Evolution, LTE.
